(19) United States
(12) Patent Application Publication
(10) Pub. No.: US 2011/0154483 A1
(43) Pub. Date: Jun. 23, 2011

(54) ELECTRONIC DEVICE WITH PASSWORD PROTECTION FUNCTION AND METHOD THEREOF

(75) Inventors: TING-KAI WANG, Tu-Cheng (TW); JING-JING YANG, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/888,421

(22) Filed: Sep. 23, 2010

(30) Foreign Application Priority Data
Dec. 22, 2009 (CN) 200910312025.4

(51) Int. Cl. H04L 9/32; G06F 21/00

(52) U.S. Cl. 726/19

(57) ABSTRACT

An electronic device with a password protection function is provided. The electronic device provides a password input area, which includes a number of sub-areas. Each of the sub-areas is designated a distinctive attribute, and is provided for inputting a single character. The characters and the attributes of the sub-areas are used to generate a login password according to a predetermined rule, thus the security of the login password is strengthened.

### BACKGROUND

1. Technical Field

The present disclosure relates to an electronic device with a password protection function and a method thereof.

2. Description of Related Art

If an electronic device, such as a remote server, has an authorization function, when a user logins onto the electronic device, a user ID and a password registered before are required to be input. Generally, the user ID and the password are a combination of characters and numbers. When the user inputs the user ID and the password online, the user ID and the password can be easily stolen by a Trojan-horse program, and thus resulting in the loss of the personal information of the user.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an electronic device with a password protection function in accordance with an exemplary embodiment.

FIG. 2 is a schematic diagram of a registration interface displayed in the electronic device of FIG. 1.

FIG. 3 is a schematic diagram of a login interface displayed in the electronic device of FIG. 1.

FIG. 4 is a flowchart of a method for registering with the electronic device of FIG. 1.

FIG. 5 is a flowchart of a method for logging into the electronic device of FIG. 1.

### DETAILED DESCRIPTION

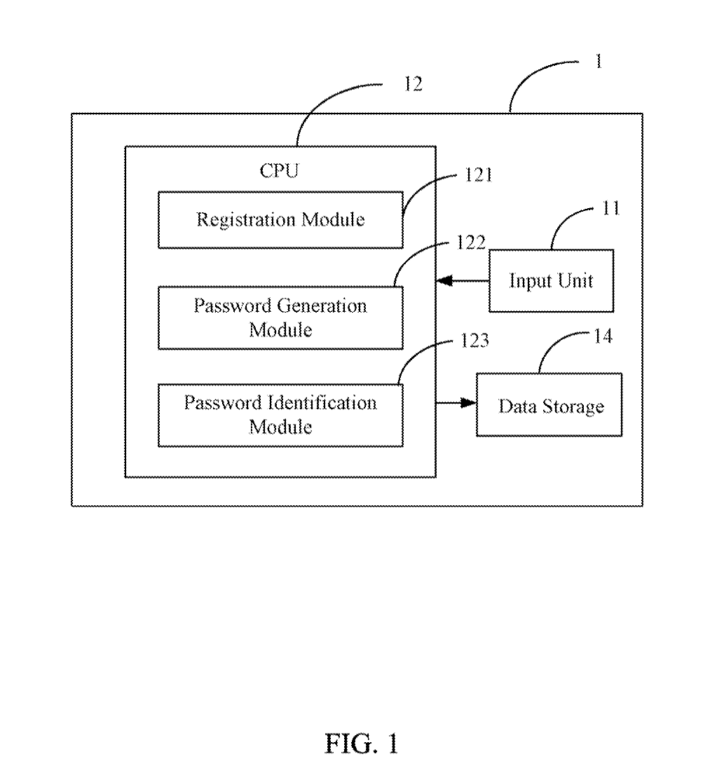

Referring to FIGS. 1-3, an electronic device with a password protection function is provided. The electronic device 1 provides a password input area which includes a number of sub-areas. Each of the sub-areas is designated a distinctive attribute, and is provided for inputting a single character. The characters and the attributes of the sub-areas are used to generate a login password according to a predetermined rule, thus the security of the login password is strengthened. The detail of the electronic device 1 is described in the following embodiment.

FIG. 1 is a block diagram of an electronic device 1 with a password protection function (here after “the electronic device”) in accordance with an exemplary embodiment. The electronic device 1 includes an input unit 11, a central processing unit (CPU) 12, and a data storage unit 14. The input unit 11 receives input from the user and generates input signals associated with the input. The CPU 12 includes a registration module 121, a password generation module 122, and a password identification module 123.

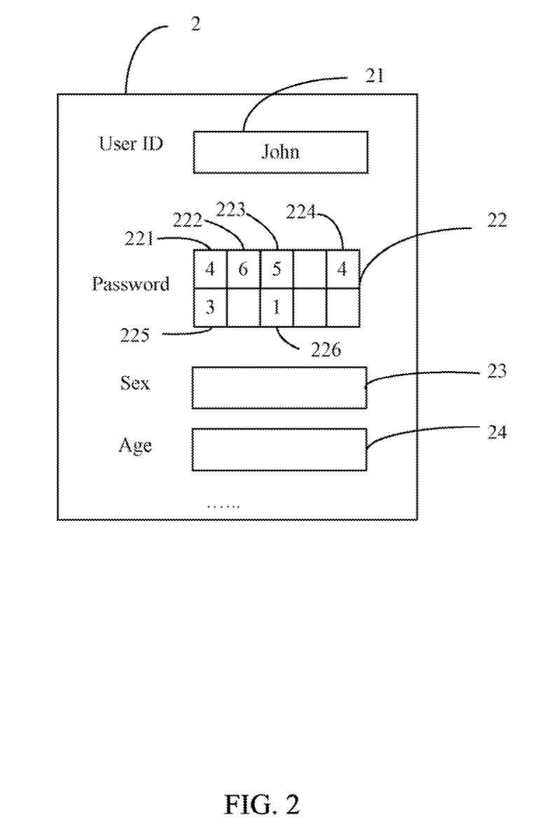

The registration module 121 receives a registration signal associated with a registration input from the input unit 11 and generates a registration interface 2, as shown in FIG. 2 according to the received registration signal. The registration interface 2 is generated for the user to register personal information with the electronic device 1. The registration interface 2 includes a user ID input area 21 and a password input area 22. The user ID input area 21 is for inputting a registration ID, and the password input area 22 is for inputting a registration password related to the registration ID. The registration interface 2 further includes additional input areas for inputting additional personal information, for example, a sex input area 23 for inputting sex, and an age input area 24 for inputting age. The password input area 22 includes a number of sub-areas. Each of the sub-areas is provided for inputting a single character. When input registration password, not all the sub-areas need to input characters, user can select several of the sub-areas to input characters. For example, as shown in FIG. 2, there are ten sub-areas illustrated and six sub-areas labeled, namely a first sub-area 221, a second sub-area 222, a third sub-area 223, a fifth sub-area 224, a sixth sub-area 225, and an eighth sub-area 226.

The six labeled sub-areas are selected to input characters 4, 6, 5, 4, 3, and 1. Different user can select different sub-areas to input characters. Each of the sub-areas is designated a distinctive attribute. In the exemplary embodiment, the attribute of each sub-area can be an identification code designated to represent each sub-area or an area size of each sub-area. The identification codes of the ten sub-areas can be 1, 2, 3, 4, 5, 6, 7, 8, 9, and 10.

After all the personal information is input, the registration module 121 generates the registration password according to the characters input in the sub-areas and the attributes of the corresponding sub-areas through a predetermined rule. The predetermined rule combines the characters and the attributes and puts the characters in front of the attributes. For example, if the characters input in the first sub-area 221, the second sub-area 222, the third sub-area 223, the fifth sub-area 224, the sixth sub-area 225, and the eighth sub-area 226 are 4, 6, 5, 4, 3, and 1. The identification code of the first sub-area 221, the second sub-area 222, the third sub-area 223, the fifth sub-area 224, the sixth sub-area 225, and the seventh sub-area 226 respectively are 1, 2, 5, 6, and 7. The registration password is 46543112567 according to the predetermined rule. The predetermined rule can be provided by the electronic device 1 or can be defined by the user. After the registration password is generated, the registration module 121 stores the registration ID, the registration password, and additional personal information to the data storage 14.

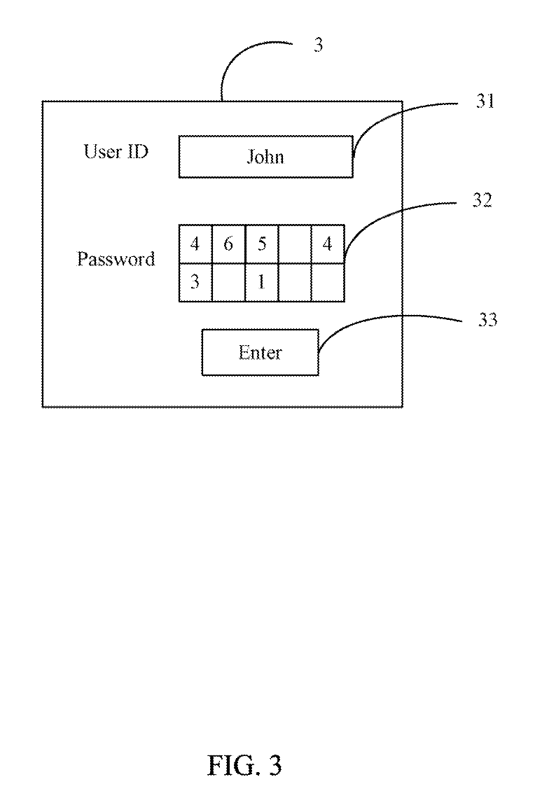

The password generation module 122 is for receiving a login signal associated with a login input from the input unit 11 and generates a login interface 3, as shown in FIG. 3, according to the received login signal. The login interface 3 includes a user ID input area 31, a password input area 32, and an enter button 33. The user ID input area 31 is for inputting a login ID. The password input area 32 is for inputting a login password related to the login ID. The structure of the password input area 32 of the login interface 3 is the same as the password input area 22 of the registration interface 2, namely, the number and the attributes of the sub-areas of the password input area 32 are the same as that of the password input area 22. If user registered with the electronic device 1 before, user can input the login ID and the login password according to the registration ID and the registration password. For example, user can input John registered before as the login ID, input characters 4, 6, 5, 4, 3, and 1 to corresponding sub-areas to generate login password. After the enter button 33 is pressed, the password generation module 122 generates the login password according to the characters input in the sub-areas of the password input area 32 and the attributes of the corresponding sub-areas through the same predetermined rule.

The password identification module 123 determines whether the login ID and the login password match the registration ID and the registration password stored in the data storage 14. If the login ID and the login password do not match the registration ID and the registration password, the password identification module 123 generates a notice to notify the user that the login password and/or the login ID is incorrect. If the login ID and the login password match the registration ID and the registration password, the user is allowed to access required data in the electronic device 1.

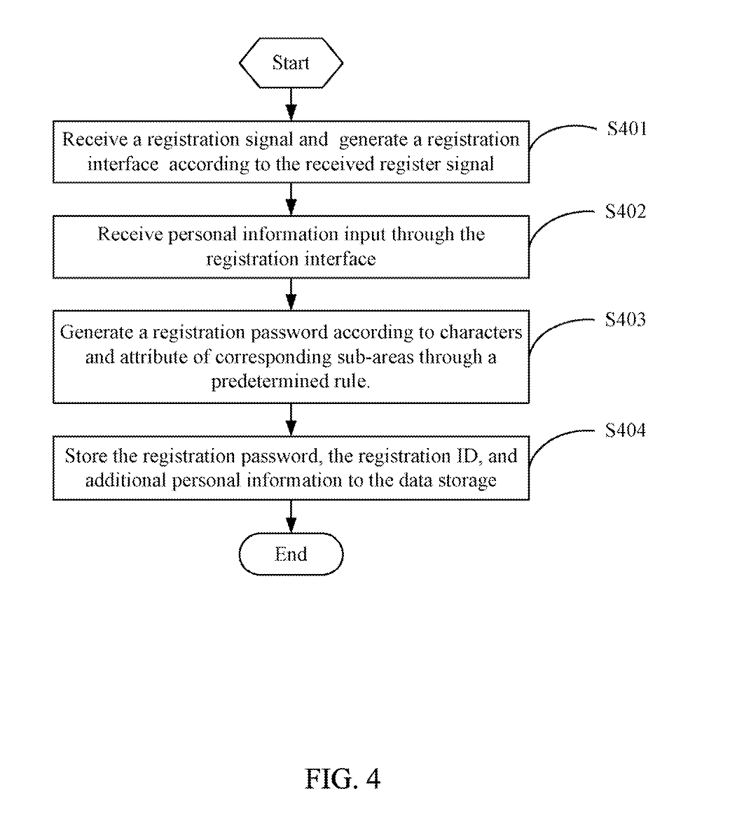

FIG. 4 is a flowchart of a method for registering with the electronic device 1 of FIG. 1. In step S401, the registration module 121 receives the registration signal associated with the registration input from the input unit 11 and generates the registration interface 2 according to the received registration signal.

In step S402, the registration module 121 receives the personal information input through the registration interface 2.

In step S403, the registration module 121 generates the registration password according to the characters input in the sub-areas of the password input area 22 and the attributes of the corresponding sub-areas through the predetermined rule.

In step S404, the registration module 121 stores the registration ID, the registration password, and additional personal information to the data storage 14.

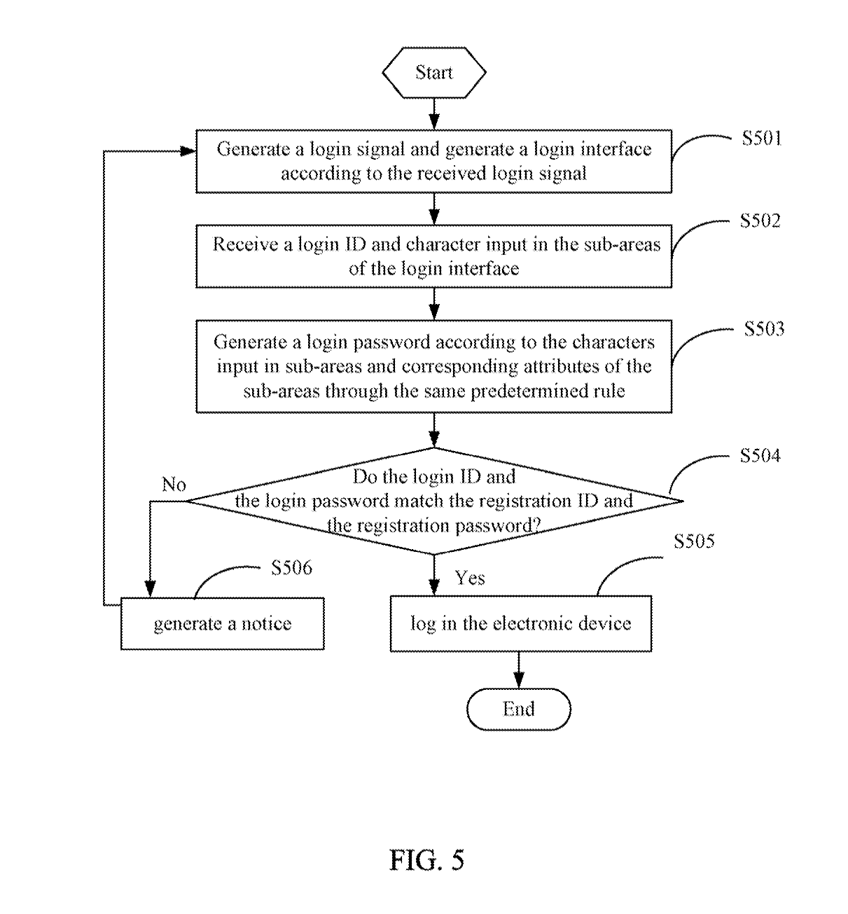

FIG. 5 is a flowchart of a method for logging onto the electronic device 1 of FIG. 1. In step S501, the password generation module 122 generates the login signal associated with the login input from the input unit 11 and generates the login interface 3 according to the received login signal.

In step S502, the password generation module 122 receives the login ID and the characters input in the sub-areas of the login interface 3.

In step S503, after the enter button 33 is pressed, the password generation module 122 generates the login password according to the characters input in the sub-areas of the password input area 32 and the attributes of the corresponding sub-areas through the predetermined rule.

In step S504, the password identification module 123 determines whether the login ID and the login password match the registration ID and the registration password stored in the data storage 14.

In step S505, the password identification module 123 generates the notice to notify the user that the password and/or login password is incorrect if the login ID and the login password do not match the registration ID and the registration password.

In step S506, the user is allowed to access the required data if the login ID and the login password match the registration ID and the registration password.

Although, the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An electronic device with a password protection function, comprising:
a data storage;
a registration module for generating a registration interface in response to a registration operation, the registration interface comprising a user ID input area provided for inputting a registration ID, a password input area provided for inputting characters for generating a registration password, the password input area comprising a plurality of sub-areas, each of which has a distinctive attribute, wherein when the registration ID and the characters are input, the registration module further generates the registration password according to the characters input in the sub-areas of the password input area and the attributes of the corresponding sub-areas through a predetermined rule, and stores the registration ID and the registration password to the data storage;
a password generation module for generating a login interface in response to a login operation, the login interface comprising a user ID input area provided for inputting a login ID and a password input area provided for inputting characters related to a login password, the password input area of the login interface comprising a plurality of sub-areas which are same as that of the password input area of the registration interface, wherein after the login ID and the characters are input, the password generation module further generates a login password according to the characters input in the sub-areas of the password input area and the attributes of the corresponding sub-areas through the predetermined rule; and
a password identification module for determining whether the login ID and the login password match the registration ID and the registration password stored in the data storage, and logging the electronic device to access required data if the login ID and the login password match the registration ID and the registration password.

2. The electronic device as described in claim 1, wherein when the registration password is input, several of the sub-areas are selected to input characters.

3. The electronic device as described in claim 1, wherein the attribute of each sub-area is an identification code designated to represent each sub-area or an area size of each sub-area.

4. The electronic device as described in claim 3, wherein the predetermined rule is combining the characters input in the sub-areas and the identification codes of the corresponding sub-areas and putting the characters in front of the identification codes.

5. The electronic device as described in claim 1, wherein the registration interface further comprises another input areas provided for inputting additional personal information.

6. The electronic device as described in claim 1, wherein each sub-area is designated to input a single character.

7. The electronic device as described in claim 1, wherein the password identification module generates a notice if the login ID and the login password do not match the registration ID and the registration password.

8. A password protection method comprising:
generating a registration interface in response to a registration operation, the registration interface comprising a user ID input area provided for inputting a registration ID, a password input area provided for inputting characters related to a registration password, the password input area comprising a plurality of sub-areas, each of which has a distinctive attribute;
generating the registration password according to the characters input in the sub-areas of the password input area and the attributes of corresponding sub-areas of the password input area through a predetermined rule when the registration ID and the characters are input;
storing the registration ID and the registration password;
generating a login interface in response to a login operation, the login interface comprising a user ID input area provided for inputting a login ID and a password input area provided for inputting characters related to a login password, the password input area of the login interface comprising a plurality of sub-areas which are same as that of the password input area of the registration interface,
generating a login password according to the characters input in the sub-areas of the password input area and the attributes of corresponding sub-areas of the password input area through the predetermined rule after the login ID and the characters are input;
determining whether the login ID and the login password match the registration ID and the registration password; and
logging the electronic device to access required data if the login ID and the login password match the registration ID and the registration password.

9. The method as described in claim 8, wherein the attribute of each sub-area is an identification code designated to represent each sub-area or an area size of each sub-area.

10. The method as described in claim 9, wherein the predetermined rule is combining the characters input in the sub-areas and the identification code of the sub-areas associated with the characters and putting the characters in front of the identification code.

11. The method as described in claim 8, wherein the registration interface further comprises another input areas provided for inputting additional personal information.

12. The method as described in claim 8, wherein each sub-area is designated to input a single character.

13. The method as described in claim 8, further comprising generating a notice if the login ID and the login password do not match the registration ID and the registration password.
